(19) United States
(12) Patent Application Publication
(10) Pub. No.: US 2026/0296128 A1
(43) Pub. Date: Oct. 1, 2026

(54) AIRFLOW DIVERTER BOX AND CONTROL METHODS THEREFOR

(71) Applicant: Honda Motor Co., Ltd., Tokyo (JP)

(72) Inventors: Kevin Cheung, Columbus, OH (US); Trevor F. Burns, Milford Center, OH (US); Clayton M. Duval, Marysville, OH (US); Jason C. D. Chuang, Hilliard, OH (US)

(21) Appl. No.: 19/095,813

(22) Filed: Mar. 31, 2025

(51) Int. Cl. B60H 1/00

(52) U.S. Cl. CPC B60H 1/00028; B60H 1/00835; B60H 2001/002

(57) ABSTRACT

Vehicle climate control systems and methods of airflow control within a vehicle are provided. The systems include front and rear blower assemblies. The front blower assembly directed heated airflow to a front of the vehicle cabin through primary front vents. The rear blower assembly is selectively transitionable between a first configuration, in which heated airflow is directed to a rear of the vehicle cabin, and a second configuration, in which heated airflow is directed to the front of the vehicle cabin through secondary front vents, using an airflow diverter box.

### BACKGROUND

The field of the disclosure relates generally to vehicle cabin climate control, and, more particularly, to an airflow diverter box configured to redirect air, including recirculated air, within a vehicle cabin.

In electric vehicles (EVs), travel range remains a significant concern for many consumers. Vehicle cabin heating, ventilation, and air conditioning (HVAC) requires a large amount of energy from the EV battery, this energy demand negatively impacting the travel range for the EV.

Accordingly, there is a need for a vehicle cabin climate control system with improved efficiency.

### BRIEF DESCRIPTION

In one aspect, a vehicle cabin climate control system of a vehicle is disclosed. The vehicle cabin climate control system includes a front blower assembly having a plurality of front ducts in fluid communication between a front blower and a plurality of primary front vents arranged within a front portion of a cabin of the vehicle. The vehicle cabin climate control system also includes a rear blower assembly having a plurality of rear ducts in fluid communication between a rear blower and a plurality of rear vents arranged within a rear portion of the cabin, a plurality of redirection ducts in fluid communication between the rear blower and a plurality of secondary front vents arranged within the front portion of the cabin, and an airflow diverter box. The airflow diverter box is selectively transitionable between a first configuration, in which airflow is permitted to flow to the plurality of rear vents, and a second configuration, in which airflow is permitted to flow to the plurality of secondary front vents and not to the plurality of rear vents.

In another aspect, a vehicle cabin climate control system for a vehicle is disclosed. The vehicle cabin climate control system includes a plurality of primary front vents arranged within a front portion of a cabin of the vehicle, and a front blower assembly including a front blower and a plurality of front ducts in fluid communication between the front blower and the plurality of primary front vents. The vehicle cabin climate control system also includes a plurality of secondary front vents arranged within the front portion of the cabin and a plurality of rear vents arranged within a rear portion of the cabin. The vehicle cabin climate control system further includes a rear blower assembly having a rear blower, a plurality of rear ducts in fluid communication between the rear blower and the plurality of rear vents, a plurality of redirection ducts in fluid communication between the rear blower and the plurality of secondary front vents, and an airflow diverter box. The airflow diverter box is selectively transitionable between a first configuration, in which airflow is permitted to flow to the plurality of rear vents, and a second configuration, in which airflow is permitted to flow to the plurality of secondary front vents and not to the plurality of rear vents.

In yet another aspect, a method of airflow control within a cabin of a vehicle is disclosed. The method includes operating a front blower assembly to generate a first heated airflow for a front portion of the cabin, the first heated airflow directed to a plurality of primary front vents arranged in the front portion of the cabin. The method also includes selectively operating a rear blower assembly to generate a second heated airflow while in a first configuration, the second heated airflow directed to a plurality of rear vents arranged in a rear portion of the cabin. The method further includes selectively operating the rear blower assembly to generate the second heated airflow while in a second configuration, the second heated airflow directed to a plurality of secondary front vents arranged in the front portion of the cabin.

### BRIEF DESCRIPTION OF THE DRAWINGS

FIG. 1 is a schematic diagram of a vehicle including a vehicle cabin climate control (VCCC) system in accordance with the present disclosure.

FIG. 2 is a simplified view of an exemplary vehicle cabin, illustrating airflow of heated air from the VCCC system shown in FIG. 1 in a first configuration.

FIG. 3 is a simplified view of the vehicle cabin shown in FIG. 2, illustrating airflow of heated air from the VCCC system in a second configuration.

FIG. 4 is a perspective view of an exemplary embodiment of an airflow diverter box of the VCCC system shown in FIG. 1, depicted in a first configuration.

FIG. 5 is a perspective view of the airflow diverter box shown in FIG. 4, depicted in a second configuration.

FIG. 6 is a perspective view of a rear blower assembly of the VCCC system shown in FIG. 1 including another exemplary embodiment of an airflow diverter box.

FIG. 7 is a front perspective view the airflow diverter box shown in FIG. 6.

FIG. 8 is a rear perspective view of the airflow diverter box shown in FIG. 6.

FIG. 9 is a flow diagram of a method of airflow control in accordance with the present disclosure.

### DETAILED DESCRIPTION

As described herein, a vehicle cabin climate control (VCCC) system includes a front blower assembly and a rear blower assembly. The front blower assembly includes a front blower coupled in fluid communication with a plurality of front ducts that direct air from the front blower to a plurality of primary front vents that are arranged in a front section of the vehicle cabin. The rear blower assembly includes a rear blower coupled in fluid communication with a plurality of rear ducts and a plurality of redirection ducts. The rear ducts direct air from the rear blower to a plurality of rear air vents that are arranged in a rear section of a vehicle cabin. The redirection ducts direct air from the rear blower to a plurality of secondary front air vents that are arranged in the front section of the vehicle cabin.

The rear blower assembly also includes an airflow diverter box configured to selectively allow airflow through the rear ducts, the redirection ducts, or both. Specifically, when the airflow diverter box is in a first configuration, airflow from the rear blower is routed fully through the rear ducts (that is, not through the redirection ducts). When the airflow diverter box is in a second configuration, airflow from the rear blower is routed fully through the redirection ducts (that is, not through the rear ducts). According to this arrangement, when certain conditions are met to transition the airflow diverter box from the first configuration to the second configuration (e.g., airflow to the rear section of the vehicle cabin is deactivated), airflow from the rear blower is redirected to the plurality of secondary front vents and, therefore, to the front section of the vehicle cabin.

The VCCC system of the present disclosure distinguishes and improves over at least some known cabin climate control systems. For example, in some known systems, some control components are located within a heating, ventilation, and air conditioning (HVAC) box. In the exemplary embodiments of the present disclosure, the airflow diverter box, configured to divert air from the rear of the vehicle cabin to the front, is located separate from the HVAC box. This arrangement may facilitate simplified installation and service.

Moreover, in some known systems, rear airflow, which is typically recirculated cabin air, may be diverted to existing front vents, thereby mixing rear and front airflows to be exhausted through the front vents. In some instances, the amount of recirculated airflow through these front vents is required to be limited, for example, due to fogging concerns. In the exemplary embodiments of the present disclosure, separate and dedicated secondary or auxiliary front vents are positioned within the front of the vehicle cabin. In this way, when the rear airflow is diverted to the front of the vehicle cabin, there is no mixing of airflow produced by the front blower and airflow produced by the rear blower, and there is no impact on the limited amount of recirculated air allowed to exit the front vents. In other words, in the exemplary embodiment, airflow produced by the rear blower can be output into the front of the vehicle cabin through the secondary auxiliary front vents without negatively effecting window fogging. This arrangement increases the overall efficiency of the VCCC system, because more recirculated—and, therefore, already heated-air is provided to the vehicle cabin, reducing the need for outside—unheated—air to be introduced into the HVAC system. In an exemplary test, power usage was measured and compared between two vehicle HVAC systems. The first HVAC system included only a front blower operating to achieve and maintain the vehicle interior temperature at a predefined temperature. The second HVAC system included both a front blower and a rear blower, the rear blower providing airflow to the front of the vehicle cabin through auxiliary front vents. Results of this test demonstrated that the vehicle HVAC system incorporating both front and rear blowers achieved and maintained the predefined temperature while using approximately 20% less power over the length of the test than the vehicle HVAC system that included only a front blower. The increased efficiency is attributed to at least the two blowers concurrently running at lower speeds than the single front blower and the utilization of a higher percentage of recirculated air. Further, the separation of heating functionality into two separate blower assemblies, providing separate airflows, may facilitate quieter operation than a single blower assembly operating at a higher speed to provide a same airflow output.

Various embodiments of climate control systems and related methods are provided. It should be noted that although the various embodiments are described in connection with electric vehicle technology, one or more embodiments may be implemented in different industries and/or for different applications including, for example, gas-powered vehicles, hybrid vehicles, aircraft, watercraft, and recreational vehicles (e.g., all-terrain vehicles). Various embodiments will be better understood when read in conjunction with the appended drawings.

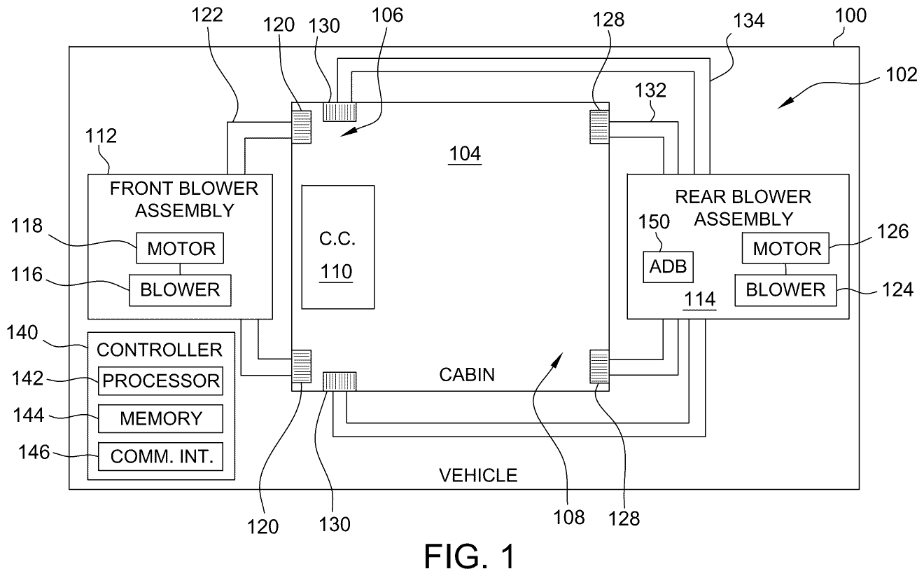

FIG. 1 is a schematic diagram of a vehicle 100 including a vehicle cabin climate control (VCCC) system 102 in accordance with the present disclosure. In the exemplary embodiment, vehicle 100 has a cabin 104 that may be occupied by a driver and passenger(s). Cabin 104 has a front 106, which generally corresponds to a location of front seats (not shown in FIG. 1) that may be occupied by the driver and any front passenger-seat passenger, and a rear 108, which generally corresponds to a location of rear seats (including second and/or third-row seats, not shown in FIG. 1) that may be occupied by any rear-seat passengers. Vehicle 100 also includes a climate control interface 110, which is typically located within cabin front 106. Climate control interface 110 enables the occupant to select a climate control mode (e.g., heating, cooling, fan-only), a desired temperature, a desired airflow direction (e.g., directed toward the feet, toward the face, toward the windshield, etc.), a blower speed, a volume of airflow, whether to recirculate cabin air, and other such settings. In some embodiments, climate control interface 110 is included in VCCC system 102; in other embodiments, climate control interface 110 is functionally separate therefrom.

VCCC system 102 includes a front blower assembly 112 and a rear blower assembly 114. Front blower assembly 112 includes various components that generate an airflow, such as a front blower 116 and a motor 118. Front blower assembly 112 is configured to operate based on settings selected by an occupant of vehicle 100 using climate control interface 110.

A plurality of primary front vents 120 are positioned within cabin front 106 and are configured to enable airflow therethrough into cabin front 106, when primary front vents 120 are open and climate control settings are controlling front blower assembly 112 to operate (e.g., based on settings input at climate control interface 110). Primary front vents 120 may be positioned in various locations, such as within or adjacent to a vehicle dashboard, adjacent to the vehicle's windshield, along or adjacent to a floor of cabin front 106, within front vehicle side panels, and the like.

Front blower assembly 112 also includes a plurality of front ducts 122, two of which are depicted in FIG. 1, although front blower assembly 112 may include any suitable number of front ducts 122. Front ducts 122 are fluidly coupled between front blower 116 and primary front vents 120 and direct airflow from front blower 116 to cabin front 106 through primary front vents 120.

Rear blower assembly 114 includes various components that generate an airflow, such as a rear blower 124 and a motor 126. Rear blower assembly 114 is configured to operate based on settings selected by an occupant of vehicle 100 using climate control interface 110. In the exemplary embodiment, rear blower 124 is a recirculation blower configured to generate a recirculated airflow. This recirculated airflow is a higher concentration of recirculated (heated) air than a recirculated airflow generated by front blower 116 due to regulatory limits on the amount of recirculated airflow allowed to exit typical front vents. For example, in some embodiments, rear blower 124 may generate a 100% recirculated, heated airflow.

A plurality of rear vents 128 are positioned within cabin rear 108 and are configured to enable airflow therethrough into cabin rear 108, when rear vents 128 are open and climate control settings are controlling rear blower assembly 114 to operate (e.g., based on settings input at climate control interface 110). Rear vents 128 may be positioned in various locations, such as within a roof of vehicle cabin 104, along or adjacent to a floor of cabin rear 108, within rear vehicle side panels, within a center console (not shown), and the like.

In addition, a plurality of secondary front vents 130 are positioned within cabin front 106. Secondary front vents 130 are distinct from primary front vents 120. In the exemplary embodiment, secondary front vents 130 are located within front vehicle side panels (not specifically shown in FIG. 1). Additionally or alternatively, secondary front vents 130 may be located along or adjacent to a floor of cabin front 106, within a floor-facing portion of the vehicle dashboard, and the like.

Rear blower assembly 114 includes a plurality of rear ducts 132, two of which are depicted in FIG. 1, although rear blower assembly 114 may include any suitable number of rear ducts 132. Rear ducts 132 are fluidly coupled between rear blower 124 and rear vents 128 and direct airflow from rear blower 124 to cabin rear 108 through rear vents 128. Rear blower assembly 114 also includes a plurality of redirection ducts 134, two of which are depicted in FIG. 1, although rear blower assembly 114 may include any suitable number of redirection ducts 134. Redirection ducts 134 are fluidly coupled between rear blower 124 and secondary front vents 130 and direct airflow from rear blower 124 to cabin front 106 through secondary front vents 130.

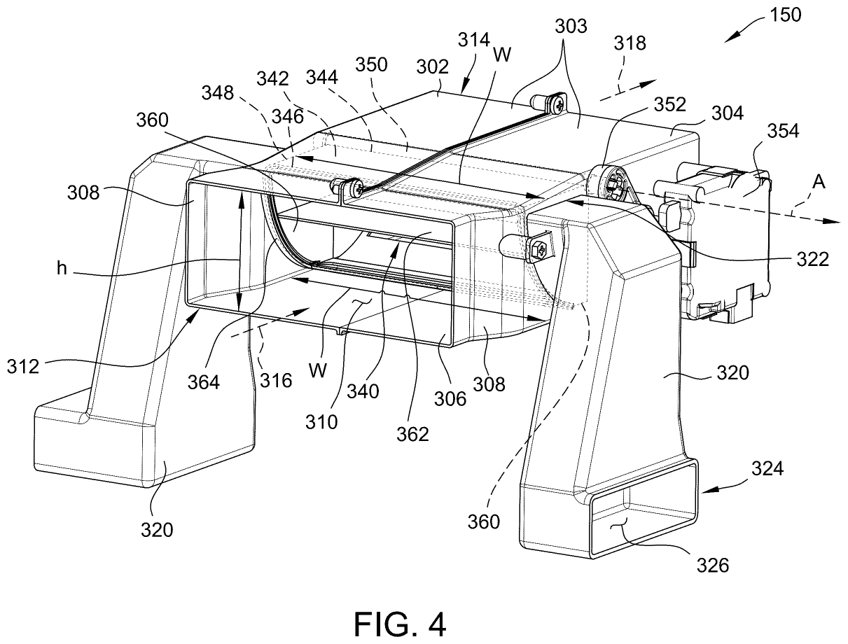

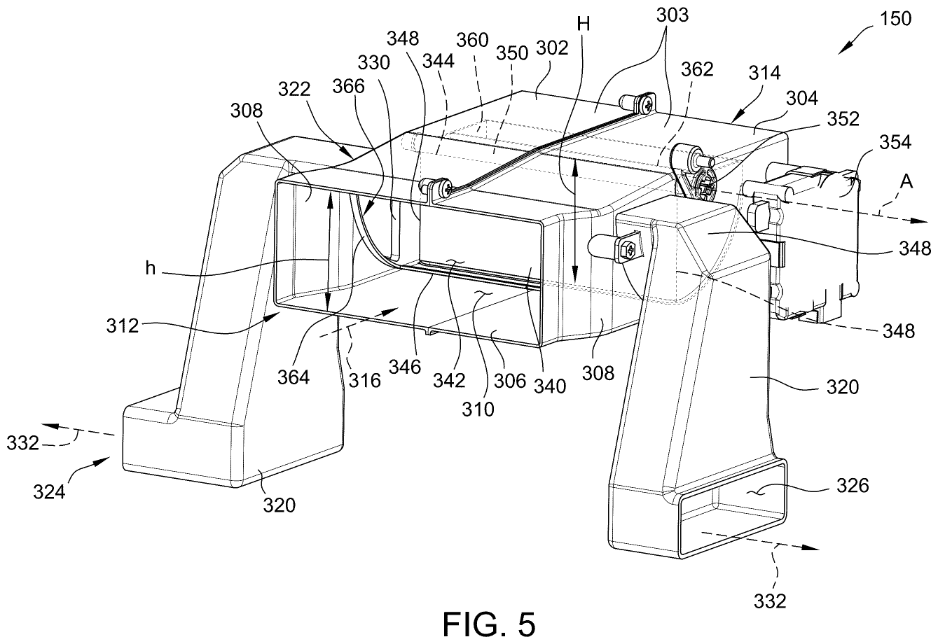

In the exemplary embodiment, rear blower assembly 114 further includes an airflow diverter box 150. Airflow diverter box 150 is configured to selectively permit airflow through rear ducts 132, redirection ducts 134, or both. Specifically, when the airflow diverter box 150 is in a first configuration (see FIG. 4), airflow from rear blower 124 is routed completely through rear ducts 132 and not through redirection ducts 134. When airflow diverter box 150 is in a second configuration (see FIG. 5), airflow from rear blower 124 is routed completely through redirection ducts 134 and not through rear ducts 132. Airflow diverter box 150 is selectively transitionable between the first and second configurations, based on various conditions associated with vehicle 100 and/or VCCC system 102, as described herein.

In some embodiments, airflow diverter box 150 is further selectively transitionable to a third configuration (not specifically shown). When airflow diverter box 150 is in the third configuration, intermediate to the first and second configurations, airflow from rear blower 124 flows through rear ducts 132 as well as redirection ducts 134.

With reference to FIGS. 1-3, a simplified view of a vehicle cabin, for example, vehicle cabin 104 (shown in FIG. 1) is depicted. In FIG. 2, VCCC system 102 (shown in FIG. 1) is in a first configuration, which corresponds to airflow diverter box 150 being in the first configuration. That is, as used herein, the “first configuration” may refer equally and interchangeably to the first configuration of airflow diverter box 150, a first configuration of rear blower assembly 114, and the first configuration of VCCC system 102. As illustrated, under this first configuration, heated airflow 202 from front blower 116 (not shown in FIG. 2) is directed into cabin front 106 through primary front vents 120. Heated airflow 204 from rear blower 124 (not shown in FIG. 2) is directed into cabin rear 108 through rear vents 128.

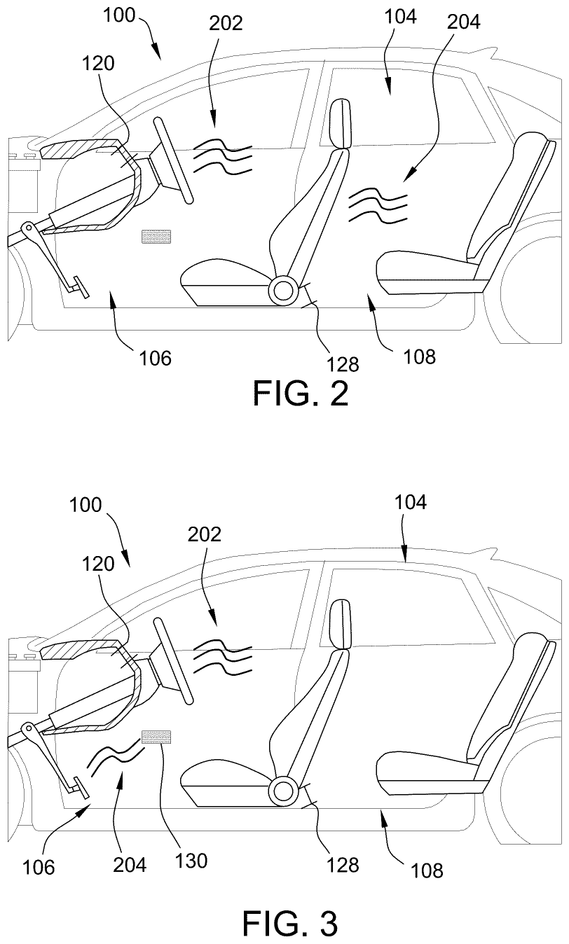

In FIG. 3, VCCC system 102 is in a second configuration, which corresponds to airflow diverter box 150 being in the second configuration. That is, as used herein, the “second configuration” may refer equally and interchangeably to the second configuration of airflow diverter box 150, a second configuration of rear blower assembly 114, and the second configuration of VCCC system 102. Therefore, airflow diverter box 150, rear blower assembly 114, and/or VCCC system 102 may each be referred to as selectively operating in or under the first configuration and selectively operating in or under the second configuration. As illustrated, under the second configuration, heated airflow 202 from front blower 116 (not shown in FIG. 3) is directed into cabin front 106 through primary front vents 120. Heated airflow 204 from rear blower 124 (not shown in FIG. 3) is also directed into cabin front 106, through secondary front vents 130, which are separate from and in addition to primary front vents 120.

The configuration of airflow diverter box 150 is controlled, in part, based on inputs to climate control interface 110. In the exemplary embodiment, airflow diverter box 150 is in the first configuration “by default” and is controlled to transition to the second configuration when a plurality of conditions are met. At least some of these conditions are manually controlled or set by an occupant of vehicle 100, for example, via climate control interface 110. These conditions may include (1) airflow to cabin rear 108 is turned off or deactivated; (2) the airflow operating mode for cabin front 106 is not set to a “vent” mode (e. g, a mode where fresh air is specifically requested); and (3) a temperature setting of VCCC system 102 is not set to “low.” Additional conditions that may be required to be satisfied for airflow diverter box 150 to transition to the second configuration include (4) an ambient temperature of an environment in which vehicle 100 is operating is below a threshold value, such as less than 10° C.; and (5) a humidity within vehicle cabin 104 is below a threshold value. In alternative embodiments, additional, fewer, or alternative conditions may be required to control airflow diverter box 150 to transition from the first configuration to the second configuration. In some exemplary embodiments, when airflow diverter box 150 is in the second configuration and one or more of conditions (1)-(5) are no longer satisfied, airflow diverter box 150 may be controlled to transition from the second configuration back to the first configuration. In some embodiments, when some, but not all, of conditions (1)-(5) are met, airflow diverter box 150 may be controlled to transition to the third configuration, from either the first or the second configuration. Furthermore, a presence of passengers in cabin rear 108, as detected by sensors such as, but not limited to, weight or pressure sensors, cameras, or seat belt sensors, can be a condition used to switch between the first configuration and the second configuration. For example, when no passengers are present in cabin rear 108, the airflow diverter box 150 may be controlled more often into second configuration, focusing the airflow on the cabin location where occupants are present. In some exemplary embodiments, additional, fewer, or alternative conditions may be defined that control when airflow diverter box 150 is transitioned to the third configuration.

In the exemplary embodiment, vehicle 100 further includes a controller 140 programmed and configured to control the configuration of airflow diverter box 150 (as well as various other operations within vehicle 100). Controller 140 may be part of or integrated with climate control interface 110. In other embodiments, controller 140 is a separate component communicatively coupled to climate control interface 110 to receive information therefrom. Controller 140 is configured to receive operational data regarding selected operation of VCCC system 102, such as via climate control interface 110. Controller 140 is also configured to receive data from other components of vehicle 100, such as, but not limited to, temperature and humidity sensors (not specifically shown).

Controller 140 may be a computing device that includes a processor 142, a memory 144, and a communication interface 146. Processor 142 is coupled to memory device 144 and to communication interface 146 (e.g., via a system bus, not shown). The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, memory device 144 includes one or more devices that enable information, such as executable instructions or other data (e.g., sensor data), to be stored and retrieved. Moreover, memory device 144 includes one or more computer readable media, such as, without limitation, dynamic random-access memory (DRAM), static random-access memory (SRAM), a solid-state disk, or a hard disk. In the example embodiment, memory device 144 stores, without limitation, application source code, application object code, configuration data, additional input events, application states, or any other type of data. In the example embodiment, processor 142 may be programmed by encoding an operation using one or more executable instructions and providing the executable instructions in memory device 144.

FIG. 4 is a perspective view of a first exemplary embodiment of an airflow diverter box, for example, the airflow diverter box 150 (shown in FIG. 1). In the embodiment shown in FIG. 4, airflow diverter box 150 is in the first configuration, in which airflow is directed from rear blower 124, through rear ducts 132, to rear vents 128 (all shown in FIG. 1). FIG. 5 is a perspective view of the first exemplary embodiment of airflow diverter box 150, shown in the second configuration, in which airflow is directed from rear blower 124, through redirection ducts 134, to secondary front vents 130 (all shown in FIG. 1).

Airflow diverter box 150 includes a shell 302 having a first or top wall 304, an opposing and parallel second or bottom wall 306, and two side walls 308 that are generally perpendicular to the top and bottom walls 304, 306. These walls 304, 306, 308 define a channel 310 through shell 302. Channel 310 extends through shell 302 from a first open end 312 of shell 302, also referred to as an inlet 312, to a second open end 314 of shell 302, also referred to as an outlet 314. In the exemplary embodiment, inlet 312 is in fluid communication with rear blower 124, such that airflow 316 from rear blower 124 enters airflow diverter box 150 through inlet 312. Outlet 314 is in fluid communication with rear ducts 132, such that, when airflow diverter box 150 is in the first configuration (or the third configuration, in some embodiments), airflow 316 from rear blower 124 exits airflow diverter box 150 through outlet 314 (e.g., as airflow 318, shown in FIG. 4).

A respective intermediate duct 320 is coupled to and extends from each side wall 308. Each intermediate duct 320 extends between a first end 322, also referred to as an intermediate duct inlet 322, and a second end 324, also referred to as an intermediate duct outlet 324. A respective channel 326 is defined through each intermediate duct 320, from intermediate duct inlet 322 to intermediate duct outlet 324. A respective opening 330 (see FIG. 5) is defined in each side wall 308 of shell 302, each opening 330 in fluid communication with intermediate duct inlet 322 of the corresponding intermediate duct 320. Each intermediate duct outlet 324 is in fluid communication with at least one respective redirection duct 134, such that, when airflow diverter box 150 is in the second configuration (or the third configuration, in some embodiments), airflow from rear blower 124 exits airflow diverter box 150 through intermediate ducts 320 (e.g., as airflow 332, shown in FIG. 5) before entering redirection duct 134.

In some embodiments, shell 302 is formed from two members 303, which may be mirrored versions of one another, that are coupled together by any suitable coupling techniques, such as fasteners, adhesive, welding, soldering, melting, etc. Each shell member 303 may be molded (e.g., injection molded), printed, machined, or formed using any other suitable forming technique. In some embodiments, shell 302 is formed as a single, unitary component, and shell 302 may be molded (e.g., injection molded), printed, machined, or formed using any other suitable forming technique. In some embodiments, intermediate ducts 320 are formed separately from shell 302 and coupled to shell 302 by any suitable coupling techniques, such as fasteners, adhesive, welding, soldering, melting, etc. Each intermediate duct 320 may be molded (e.g., injection molded), printed, machined, or formed using any other suitable forming technique. In other embodiments, intermediate duct 320 are formed integrally with shell members 303 or a unitary shell 302.

Airflow diverter box 150 further includes a damper 340 arranged within the shell. Damper 340 is illustrated in a first position in FIG. 4, corresponding to airflow diverter box 150 in the first configuration, and in a second position in FIG. 5, corresponding to airflow diverter box 150 in the second configuration.

Damper 340 includes a transverse wall 342 having a top edge 344, a bottom edge 346, and opposing side edges 348. In the exemplary embodiment, damper 340 is rotatably coupled to the shell by a pin (not shown), which extends through a shaft 350 at top edge 344 of transverse wall 342 and defines a rotation axis A. One end of the pin is operatively coupled to a first end of a lever 352. An opposing second end of lever 352 is operatively coupled to a motor 354. As described further herein, motor 354 is controlled (e.g., by controller 140, shown in FIG. 1) to rotate damper 340 between positions to transition airflow diverter box 150 between configurations. Although described herein as being rotated by motor 354, the position of damper 340 may be changed using any other known actuator.

A height H of transverse wall 342 (see FIG. 5), measured between top and bottom edges 344, 346, is substantially equal to an inner height h of shell 302, measured between inner surfaces of top and bottom walls 304, 306. A width W of transverse wall 342 (see FIG. 4), measured between side edges 348, is substantially equal to an inner width w of shell 302, measured between inner surfaces of side walls 308. As used herein, “substantially equal” refers to values within an incidental range of one another, such as within 5% of one another.

Damper 340 also includes a pair of partition walls 360 extending from side edges 348 of transverse wall 342. In the exemplary embodiment, partition walls 360 are shaped as quarter circles. A radius (not shown) of partition walls 360 is substantially equal to the height H of transverse wall 342 and, therefore, to the inner height h of shell 302.

Damper 340 further includes a support panel 362 that extends between partition walls 360 and that is substantially parallel to transverse wall 342. Support panel 362 maintains the relative position of partition walls 360, preventing partition walls 360 from bending inwards towards each other during operation of airflow diverter box 150. In the exemplary embodiment, support panel 362 has a rectangular shape; in alternative embodiment, support panel 362 has any other shape that enables support panel 362 to function as described herein.

A respective arcuate ridge 364 extends from the inner surface of each side wall 308 of shell 302, into channel 310 or towards the opposite side wall 308. These ridge 364 define an engagement surface 366 (see FIG. 5). An outer radial edge of partition walls 360 contacts engagement surface 366 as damper 340 is transitioned between positions.

In the exemplary embodiment, airflow diverter box 150 is in the first configuration by default, or under most conditions. As such, damper 340 is in the first position by default. When damper 340 is in the first position (see FIG. 4), transverse wall 342 and support panel 362 are parallel to top and bottom walls 304, 306 of shell 302, enabling airflow 316 to pass through channel 310 to shell outlet 314. Moreover, partition walls 360 are arranged to cover openings 330 in side walls 308, preventing airflow 316 from passing through openings 330 and into intermediate ducts 320.

In operation, controller 140 monitors the conditions of vehicle 100 to determine when to transition airflow diverter box 150 from the first to the second configuration. For example, controller 140 monitors one or more of: a status of airflow operating modes, such as which operating mode(s) are active or deactivated, temperature settings, airflow settings, an ambient temperature around vehicle 100, a temperature within vehicle cabin 104, an ambient humidity around vehicle 100, or a humidity within vehicle cabin 104. In the exemplary embodiment, controller 140 detects one or more transition conditions are met and controls airflow divertor box 150 to transition from the first to the second configuration. As described herein, the one or more transition conditions may include: (1) airflow to cabin rear 108 is turned off or deactivated; (2) the airflow operating mode in cabin front 106 is not set to a “vent” mode; (3) a temperature setting of VCCC system 102 is not set to “low”; (4) an ambient temperature of an environment in which vehicle 100 is operating is below a threshold value, such as less than 10° C.; and (5) a humidity within vehicle cabin 104 is below a threshold value. In some embodiments, all of transitions conditions (1)-(5) must be met for controller 140 to control airflow diverter box 150 to transition from the first to the second configuration.

In operation, controller 140 transmits a control signal to motor 354 of airflow diverter box 150. Motor 354 activates in response to the control signal, and controls lever 352 to move from a first position, corresponding to damper 340 being in the first position, to a second position, corresponding to damper 340 being in the second position (see FIG. 5). Specifically, motor 354 engages the second end of lever 352 to pivot lever about the rotation axis A, in a counterclockwise direction with respect to the views of FIGS. 4 and 5. Because the pin—extending through shaft 350 of transverse wall 342—is coupled to the first end of lever 352, when lever 352 is pivoted, the pin is turned about the rotation axis A, also in the counterclockwise direction. The rotation of the pin, in turn, causes rotation of damper 340 in the counterclockwise direction.

When damper 340 is in the second position, transverse wall 342 is substantially perpendicular to top and bottom walls 304, 306 of shell 302, preventing airflow 316 from passing through channel 310 and out shell outlet 314. Partition walls 360, having been rotated towards shell outlet 314, are positioned away from openings 330 in side walls 308, enabling airflow 316 to pass through openings 330 and into intermediate ducts 320.

In alternative embodiments, additional, fewer, or alternative transition conditions may be required for controller 140 to send the control signal to motor 354 to control airflow diverter box 150 to transition from the first configuration to the second configuration.

In some exemplary embodiments, when airflow diverter box 150 is in the second configuration, controller 140 continues to monitor the status of vehicle 100 to determine when to control airflow diverter box 150 to transition back to the first configuration. When controller 140 detects that one or more of transition conditions (1)-(5) are no longer satisfied, controller 140 transmits another control signal to motor 354. Motor 354 activates in response to the control signal, and controls lever 352 to move from the second position to the first position. Specifically, motor 354 engages the second end of lever 352 to pivot lever 352 about the rotation axis A, in a clockwise direction with respect to the views of FIGS. 4 and 5. Because the pin—extending through shaft 350 of transverse wall 342—is coupled to the first end of lever 352, when lever 352 is pivoted, the pin is turned about the rotation axis A, also in the clockwise direction. The rotation of the pin, in turn, causes rotation (or pivoting) of damper 340 in the clockwise direction, from the second position to the first position.

In one alternative embodiment, when airflow diverter box 150 is in the second configuration, controller 140 continues to monitor the status of vehicle 100. When controller 140 detects that all of transition conditions (1)-(5) are no longer satisfied, controller 140 transmits another control signal to motor 354, to control airflow diverter box 150 to transition from the second configuration back to the first configuration.

In some exemplary embodiments, when airflow diverter box 150 is in the first or the second configuration, controller 140 monitors the status of vehicle 100. When controller 140 detects that some, but not all, of transition conditions (1)-(5) are met, controller 140 transmits a control signal to motor 354, to control airflow diverter box 150 to transition to the third configuration, from either the first or the second configuration. In some exemplary embodiments, additional, fewer, or alternative transition conditions may be defined that control when airflow diverter box 150 is transitioned to the third configuration. In some embodiments, when damper 340 is in a third position (not shown), corresponding to the third configuration of airflow diverter box 150, airflow is permitted to pass through shell outlet 314 and through openings 330 into intermediate ducts 320 (and, thereby, through rear ducts 132 and redirection ducts 134, to both cabin rear 108 and cabin front 106). It should be understood that motor 354 may control damper 340 to multiple third positions based on control signal(s) from controller 140, which in turn controls the relative portion of airflow through rear ducts 132 and redirection ducts 134.

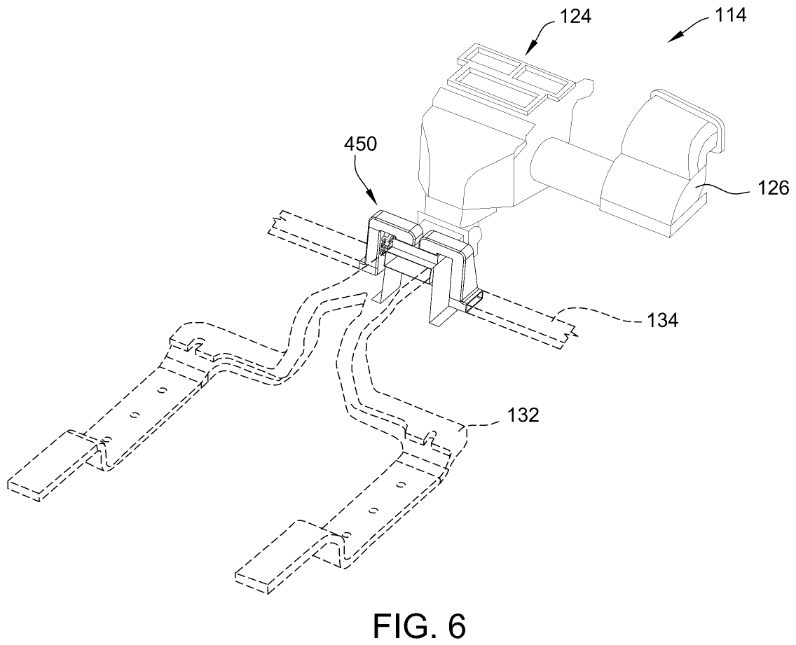

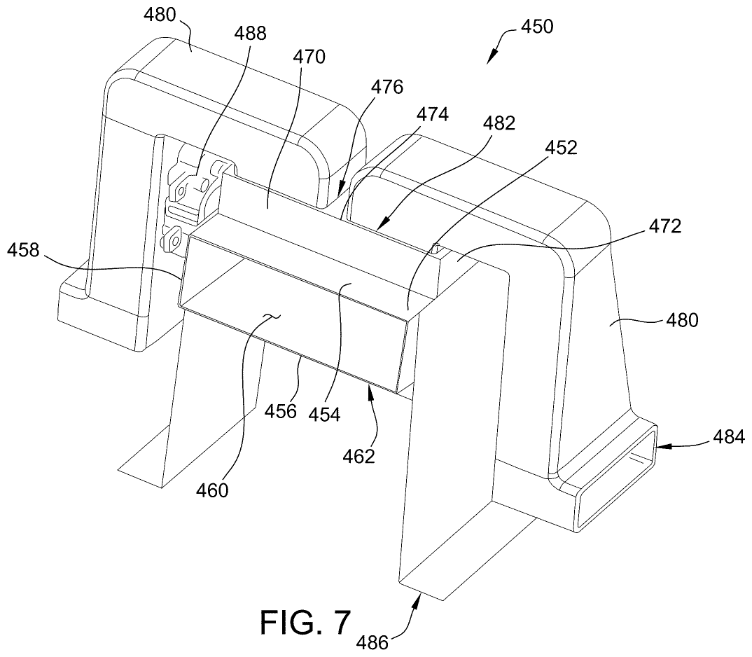

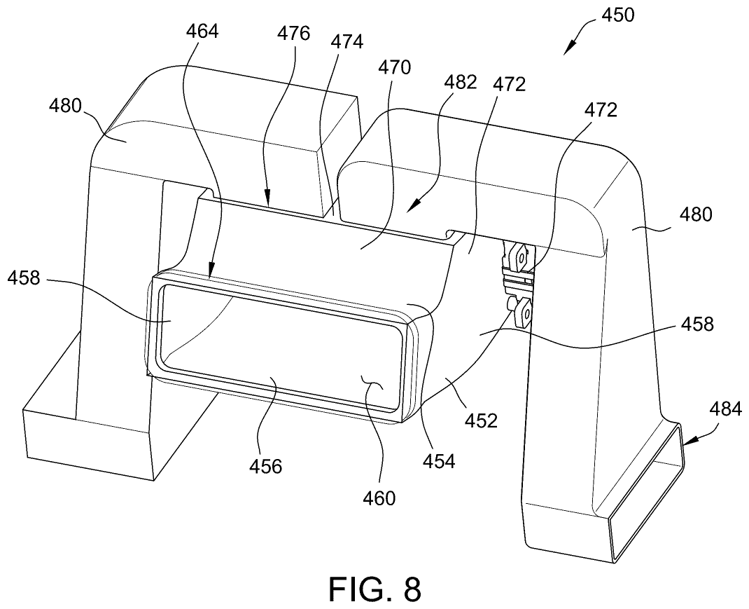

FIG. 6 depicts an exemplary rear blower assembly (e.g., rear blower assembly 114) coupled to an airflow diverter box 450. Airflow diverter box 450 is an alternate embodiment to airflow diverter box 150 (shown in FIGS. 4 and 5), and is shown in greater detail in FIGS. 7 and 8 (front and rear perspective views, respectively). As shown, rear blower assembly 114 includes rear blower 124 and motor 126. Airflow diverter box 450 is arranged between rear blower 124 and rear ducts 132 and redirection ducts 134.

Airflow diverter box 450 includes a shell 452 having a first or top wall 454, an opposing and parallel second or bottom wall 456, and two side walls 458 that are generally perpendicular to top and bottom walls 454, 456. These walls 454, 456, 458 define a channel 460 through shell 452. Channel 460 extends through shell 452 from a first open end 462 (shown in FIG. 7) of shell 452, also referred to as an inlet 462, to a second open end 464 (shown in FIG. 8) of shell 452, also referred to as an outlet 464. In the exemplary embodiment, inlet 462 is in fluid communication with rear blower 124, such that airflow from rear blower 124 enters airflow diverter box 450 through inlet 462. Outlet 464 is in fluid communication with rear ducts 132, such that, when airflow diverter box 450 is in the first configuration (or the third configuration, in some embodiments), airflow from rear blower 124 exits airflow diverter box 450 through outlet 464.

Shell 452 also includes an extension 470 that extends upwardly from top wall 454, or away from bottom wall 456. Extension 470 includes side walls 472 and a top panel 474 which collectively define a pair of extension outlets 476. Although not shown, top wall 474 has an opening defined therethrough that is in fluid communication with extension outlets 476. Two intermediate ducts 480 are coupled to extension 470. Specifically, a first end 482 of each intermediate duct 480, also referred to as an intermediate duct inlet 482, is in fluid communication with a respective one of the extension outlets 476. Each intermediate duct 480 extends from first end 482 thereof to a respective second end 484 thereof, also referred to as an intermediate duct outlet 484. Intermediate duct outlet 484 of each intermediate duct 480 is in fluid communication with at least one respective redirection duct 134, such that, when airflow diverter box 450 is in the second configuration (or the third configuration, in some embodiments), airflow from rear blower 124 exits airflow diverter box 450 through intermediate ducts 480 and into redirection ducts 134.

In some embodiments, shell 452 is formed as a single, unitary component, and shell 452 may be molded (e.g., injection molded), printed, machined, or formed using any other suitable forming technique. In some embodiments, shell 452 is formed from two members (not shown), which may be mirrored versions of one another, that are coupled together by any suitable coupling techniques, such as fasteners, adhesive, welding, soldering, melting, etc. Each shell member may be molded (e.g., injection molded), printed, machined, or formed using any other suitable forming technique. In some embodiments, intermediate ducts 480 are formed separately from shell 452 and coupled to shell 452 by any suitable coupling techniques, such as fasteners, adhesive, welding, soldering, melting, etc. Each intermediate duct 480 may be molded (e.g., injection molded), printed, machined, or formed using any other suitable forming technique. In other embodiments, intermediate ducts 480 are formed integrally with shell members or a unitary shell 452. In one or more exemplary embodiments, airflow diverter box 450 is coupled to rear blower assembly 114 via a bracket 486 (see FIG. 7).

Airflow diverter box 450 further includes a damper (not visible in the views of FIGS. 7 and 8) arranged within shell 452. The damper is operatively coupled to a motor 488. As described further herein, motor 488 is controlled (e.g., by controller 140, shown in FIG. 1) to rotate, pivot, or otherwise move the damper between positions to transition airflow diverter box 450 between configurations. In some embodiments, the damper of airflow diverter box 450 is substantially similar to damper 340 of airflow diverter box 150.

In the exemplary embodiment, airflow diverter box 450 is in the first configuration by default, or under most conditions. As such, the damper is in the first position by default. When the damper is in the first position, airflow passes through channel 460 to shell outlet 464 and is prevented from passing into extension 470. When the damper is in the second position, airflow passes through extension 470 and through intermediate ducts 480 and is prevented from passing through shell outlet 464. In operation, controller 140 transmits control signals to motor 488 of airflow diverter box 450. Motor 488 activates in response to control signals and transitions the damper between the first and second positions, as directed by the control signals. In some embodiments, controller 140 transmits control signals to motor 488, to control airflow diverter box 450 to transition to or from a third configuration, from or to either the first or second configurations. When the damper is in a third position, corresponding to the third configuration of airflow diverter box 450, airflow is permitted to pass through shell outlet 464 and through extension outlets 476 (and, thereby, through rear ducts 132 and redirection ducts 134, to both cabin rear 108 and cabin front 106). It should be understood that motor 488 may control the damper to multiple third positions based on control signal(s) from controller 140, which in turn controls the relative portion of airflow through rear ducts 132 and redirection ducts 134.

In alternative embodiments, additional, fewer, or alternative transition conditions may be required for controller 140 to send the control signal to motor 488 to control airflow diverter box 150 to transition from the first configuration to the second configuration.

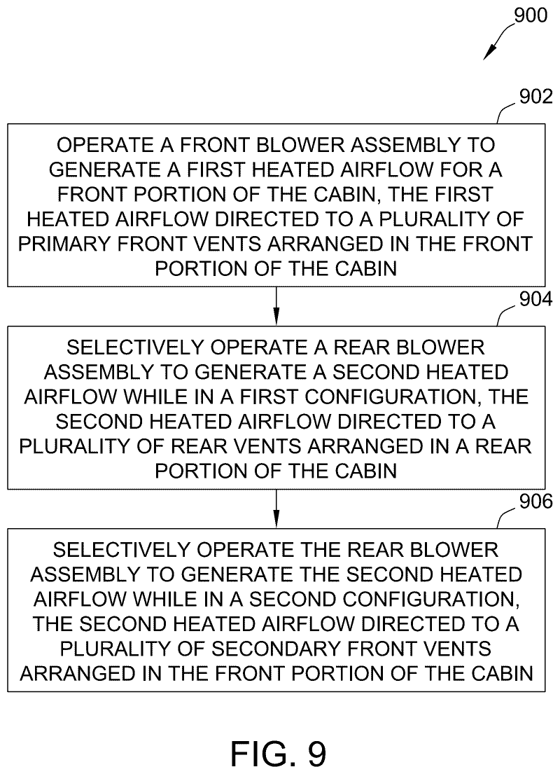

FIG. 9 is a flow chart of an exemplary method 900 of airflow control within a vehicle cabin, in accordance with the present disclosure. In the exemplary embodiment, method 900 includes operating 902 a front blower assembly to generate a first heated airflow for a front portion of the cabin, the first heated airflow directed to a plurality of primary front vents arranged in the front portion of the cabin. Method 900 also includes selectively operating 904 a rear blower assembly to generate a second heated airflow, the second heated airflow directed to a plurality of rear vents arranged in a rear portion of the cabin while an air diverter box is in a first configuration. Method 900 further includes selectively operating 906 the rear blower assembly to generate the second heated airflow and direct the second heated airflow to a plurality of secondary front vents arranged in the front portion of the cabin while the air diverter box is in a second configuration.

Method 900 may include additional, fewer, or alternative actions. For example, in some embodiments, method 900 includes operating an airflow diverter box to control the rear blower assembly to transition between the first configuration and the second configuration.

In some embodiments, method 900 further includes detecting, by a controller, satisfaction of a plurality of transition conditions, and, in response to the detecting, controlling, by the controller, the rear blower assembly to transition from the first configuration to the second configuration. The controlling may include controlling an airflow diverter box to transition the rear blower assembly from the first configuration to the second configuration. The controlling may additionally include pivoting a damper of the airflow diverter box between a first position and a second position.

Embodiments of the vehicle climate control systems described herein facilitate improving an efficiency of heating a vehicle cabin, particularly for electric vehicles. Specifically, the airflow diverter box enables additional recirculated heated airflow to be directed to the front of the vehicle cabin, when no rear cabin heating is needed. This arrangement may reduce the amount of power used to heat the front of the vehicle cabin (e.g., up to about 20% reduction in power use, in some instances), and may also facilitate quieter operation by splitting blower operation between two blower assemblies.

This written description uses examples to disclose the various embodiments, and also to enable a person having ordinary skill in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or the examples include equivalent structural elements with insubstantial differences from the literal language of the claims.

What is claimed is:

1. A vehicle cabin climate control system of a vehicle, the vehicle cabin climate control system comprising:
a front blower assembly comprising a plurality of front ducts in fluid communication between a front blower and a plurality of primary front vents arranged within a front portion of a cabin of the vehicle; and
a rear blower assembly comprising:
a plurality of rear ducts in fluid communication between a rear blower and a plurality of rear vents arranged within a rear portion of the cabin;
a plurality of redirection ducts in fluid communication between the rear blower and a plurality of secondary front vents arranged within the front portion of the cabin; and
an airflow diverter box selectively transitionable between a first configuration, in which airflow is permitted to flow to the plurality of rear vents, and a second configuration, in which airflow is permitted to flow to the plurality of secondary front vents and not to the plurality of rear vents.

2. The vehicle cabin climate control system of claim 1, wherein the airflow diverter box comprises a damper that is selectively moveable between a first position, corresponding to the first configuration, and a second position, corresponding to the second configuration.

3. The vehicle cabin climate control system of claim 1, wherein the airflow diverter box is further selectively transitionable to a third configuration, in which airflow is permitted to flow to the plurality of rear vents and the plurality of secondary front vents.

4. The vehicle cabin climate control system of claim 3, wherein the airflow diverter box comprises a damper that is selectively moveable between a first position, corresponding to the first configuration, a second position, corresponding to the second configuration, and a third position, corresponding to the third configuration.

5. The vehicle cabin climate control system of claim 1, further comprising a controller configured to:
detect that a plurality of transition conditions are satisfied; and
in response to the detecting, control the airflow diverter box to transition from the first configuration to the second configuration.

6. The vehicle cabin climate control system of claim 5, wherein the transition conditions include a plurality of controllable conditions input by an occupant of the vehicle within the cabin and a plurality of sensed conditions.

7. The vehicle cabin climate control system of claim 6, wherein the plurality of controllable conditions include: (i) whether airflow to the rear portion of the cabin is deactivated, (ii) whether an airflow operating mode of the front blower assembly is not a set to a vent operating mode, and (iii) whether a temperature setting of the vehicle cabin climate control system is not set to a low temperature setting.

8. The vehicle cabin climate control system of claim 6, wherein the plurality of sensed conditions include: (i) an ambient temperature of an environment in which the vehicle is operating is below a threshold temperature value, and (ii) a humidity within the cabin is below a threshold humidity value.

9. The vehicle cabin climate control system of claim 8, wherein the temperature threshold value is 10° C.

10. The vehicle cabin climate control system of claim 5, wherein the airflow diverter box comprises a damper, and
wherein the controller is further configured to control the airflow diverter box by controlling a motor to pivot the damper between a first position, corresponding to the first configuration, and a second position, corresponding to the second configuration.

11. The vehicle cabin climate control system of claim 1, wherein airflow to the front portion of the cabin through the primary front vents and the secondary front vents, when the airflow diverter box is in the second configuration, includes a higher amount of recirculated air than airflow to the front portion of the cabin through only the primary front vents, when the airflow diverter box is in the first configuration.

12. A vehicle cabin climate control system for a vehicle, the vehicle cabin climate control system comprising:
a plurality of primary front vents arranged within a front portion of a cabin of the vehicle;
a front blower assembly comprising:
a front blower; and
a plurality of front ducts in fluid communication between the front blower and the plurality of primary front vents;
a plurality of secondary front vents arranged within the front portion of the cabin;
a plurality of rear vents arranged within a rear portion of the cabin;
a rear blower assembly comprising:
a rear blower;
a plurality of rear ducts in fluid communication between the rear blower and the plurality of rear vents;
a plurality of redirection ducts in fluid communication between the rear blower and the plurality of secondary front vents; and
an airflow diverter box selectively transitionable between a first configuration, in which airflow is permitted to flow to the plurality of rear vents, and a second configuration, in which airflow is permitted to flow to the plurality of secondary front vents and not to the plurality of rear vents.

13. The vehicle cabin climate control system of claim 12, wherein the rear blower is a recirculation blower.

14. The vehicle cabin climate control system of claim 12, further comprising a controller configured to:
detect that a plurality of transition conditions are satisfied; and
in response to the detecting, control the airflow diverter box to transition from the first configuration to the second configuration.

15. The vehicle cabin climate control system of claim 14, wherein the airflow diverter box comprises a damper, and
wherein the controller is further configured to control the airflow diverter box by controlling a motor to pivot the damper between a first position, corresponding to the first configuration, and a second position, corresponding to the second configuration.

16. A method of airflow control within a cabin of a vehicle, the method comprising:
operating a front blower assembly to generate a first heated airflow for a front portion of the cabin, the first heated airflow directed to a plurality of primary front vents arranged in the front portion of the cabin;
selectively operating a rear blower assembly to generate a second heated airflow while in a first configuration, the second heated airflow directed to a plurality of rear vents arranged in a rear portion of the cabin; and
selectively operating the rear blower assembly to generate the second heated airflow while in a second configuration, the second heated airflow directed to a plurality of secondary front vents arranged in the front portion of the cabin.

17. The method of claim 16 further comprising:
operating an airflow diverter box to control the rear blower assembly to transition from the first configuration to the second configuration.

18. The method of claim 16, further comprising:
detecting, by a controller, a plurality of transition conditions are satisfied; and
in response to the detecting, controlling, by the controller, the rear blower assembly to transition from the first configuration to the second configuration.

19. The method of claim 18, wherein the controlling comprises controlling an airflow diverter box to transition the rear blower assembly from the first configuration to the second configuration.

20. The method of claim 19, wherein the controlling comprises pivoting a damper of the airflow diverter box from a first position to a second position.
